(19) United States
(12) Patent Application Publication
(10) Pub. No.: US 2005/0233117 A1
(43) Pub. Date: Oct. 20, 2005

(54) Simulated stained lass and process of making same

(76) Inventor: Nathan Polsky, Boynton Beach, FL (US)

Correspondence Address: BROWDY AND NEIMARK, P.L.L.C.;624 NINTH STREET, NW, SUITE 300, WASHINGTON, DC, 20001-5303, US

(21) Appl. No.: 10/823,557

(22) Filed: Apr. 14, 2004

(51) Int. Cl. B44F 1/06

(52) U.S. Cl. 428/195.1

(57) ABSTRACT

A workpiece, the product thereof, and a kit, for making simulated stained glass works of art includes a transparent sheet covered on one side by an opaque scratch-removable coating and on the other side by a second sheet having transparent-ink patterns or solid colors. Portions of the opaque coating are removed to reveal through the transparent substrate, underlying transparent-ink patterns. The partially scratched product “drawing” produces an excellent visual appearance simulative of stained glass when held up to light. The finished product can be affixed to a window for continued enjoyment.

### FIELD OF THE INVENTION

The present invention relates to an art or hobby workpiece used for making designs or pictures simulating stained glass by scratching away part of an opaque coating to reveal portions of underlying background.

### BACKGROUND

Methods are well known in the prior art for scratching a picture through an opaque or dark coating to reveal a color beneath the coating. A prior art product produced by the present inventor utilizes a wood stylus to scratch a picture through a black top coating applied to a suitable colored substrate.

One prior art patent (see Bruskin U.S. Pat. No. 4,262,042) describes a method of producing a picture such as a stained glass panel including a paint-removing step. Another prior art reference (see Childs U.S. Pat. No. 4,368,587) describes a method of making color separation plates including the steps of individually scraping a plurality of various solid colored sheets and superimposing the sheets to create offset printing plates. Other scratch-to-sketch products and processes are also known in the prior art (see for example Hess U.S. Pat. No. 4,937,103 that shows the use of a ceramic base).

Most pertinent to the present invention is the Polsky U.S. Pat. No. 5,270,087 (herein incorporated by reference) which relates to simulated stained glass and a process of making same by removal of portions of an opaque coating to reveal through a transparent substrate an underlying transparent-ink pattern. The product so made produces an excellent visual appearance, which simulates stained glass when held up to light.

A prepared pre-scratch blank or workpiece 12 disclosed in U.S. Pat. No. 5,280,087 is shown in FIG. 1, along with a scratch tool 20. The pre-scratch blank 12 is preferably made up of three main layers. The base or middle layer substrate 14 is preferably made of a generally clear transparent or translucent plastic film or sheet material, which may have a solid color inherent therein. One side of the middle layer 14 is coated or printed with a removable (by scratching with a scratch tool 20, finger, or the like) continuous opaque layer 16. Onto the opposite side of the clear middle layer substrate 14 is coated or printed a single or, more preferably, multiple color layer 18 which on drying becomes permanently attached to the clear substrate layer 14.

The scratch tool 20 is can be made of wood and can be as simple as an elongated stick which has had a stylus 22 or point carved into at least one end. Fingers may also be used.

The opaque layer 16 may be formed of any opaque coating material, i.e., one that is not transparent to light. Preferred, however, is a well-known ink known as “malleable black” which is a printing ink known in the printing industry which poorly bonds to whatever surface it is applied.

The color layer 18 is also desirably printed directly onto the clear substrate layer 14, using conventional printing techniques, such as offset printing, flexographic printing, and silkscreen printing, using conventional transparent overprinting inks. The term “transparent” as used herein is a common term for transparent inks conventionally used in the printing industry, which inks permit the passage therethrough of light. One or more layers of these conventional transparent printing inks are applied as layer 18 in various patterns, and it is normally necessary to provide only one to three layers, each with one of the three primary colors, namely magenta (red), cyan (blue) and yellow, it being understood that secondary colors are achieved by overprinting. For example, in FIG. 2, areas 182 are printed in blue, areas 184 in red, and 186 in yellow. In the area 182′, blue has been printed over red 184, so as to give the secondary color (when light shines therethrough) of violet or purple.

As indicated above, both the opaque coating 16 and the transparent layer or layers 18 can be applied to the transparent substrate 14 using any conventional prior art printing technique. Virtually any pattern or single color can be applied as the printed layer 18, the only requirement being that the ink be so-called “transparent” and adhere adequately to the substrate 14. The design illustrated in FIG. 2 is, of course, only exemplary, it being understood that the number of printed patterns is practically infinite.

The finished blank 12 is used by scratching through the opaque top blank coat 16 to reveal the colors of the pattern layer 18 on the opposite side of the plastic clear substrate 14. The drawn picture, two examples of which are shown in FIGS. 3 and 4 by reference numerals 16′ and 16″ respectively, will be black except where scratched. The black areas of FIGS. 3 and 4 are the unscratched sections and the light areas are the scratched sections, which reveal the portions of the underlying pattern 18.

FIG. 5 shows another embodiment disclosed in U.S. Pat. No. 5,280,087, wherein both the transparent ink layer(s) 18, and the opaque overcoating 16 are applied to the same side of the transparent substrate 14. As noted above, the opaque layer 16 is formed of a poorly bonding ink or coating composition such as malleable black. For this embodiment, a sharp tool 20 ought not be used, i.e., one can only utilize a relatively dull scratch tool 20 such as one formed of wood.

### SUMMARY OF THE INVENTION

It is an object of the present invention to provide an aesthetically pleasing art form, enjoyable to perform, and producing an individualized work of art similar to that of the Polsky U.S. Pat. No. 5,270,087.

It is another object of the present invention to provide an easy and safe method and workpiece for making simulated stained glass art effects.

It is a further object of the present invention to provide a method and workpiece for making simulated stained glass art using only a wooden stick or stylus as the scratching tool so that even a young child can safely create beautiful art.

It is still another object of the present invention to provide a finished simulated stained glass artwork product, which can be affixed to a windowpane where incoming light will produce, an impressive visual display for continued enjoyment.

Yet a further object of the present invention is to provide an art or hobby workpiece and a method for converting such workpiece to a simulated stained-glass artwork.

Still a further object of the present invention is to allow the user to obtain a product that can have a large variety of color options and designs, which can be interchanged with one another as desired.

The present invention is not to be taken as limited to or by the aforementioned objects.

According to one embodiment of the present invention, a workpiece is provided for making simulated stained glass art including a clear, transparent plastic sheet substrate and a transparent colored sheet disposed separately from the clear plastic sheet substrate and adjacent to a first surface of the clear plastic sheet substrate. A removable by scratching completely opaque layer covers a second surface of the clear plastic sheet substrate, the second surface being on an opposite side of the first surface, whereby the opaque layer can be partially removed in selected patterns by scratching with a tool or with fingers to reveal the transparent color sheet through the clear transparent sheet substrate.

The opaque layer is malleable black or any other malleable color. The removable-by-scratching completely opaque layer can be formed of an ink or paint coating. The transparent colored sheet is either a single color sheet or a multi-colored sheet.

A kit is provided which includes at least one workpiece and the tool for scratching the opaque layer. A product is provided in which the clear and the transparent colored sheet are juxtaposed in proximity to one another. In the product, after the opaque coating has been partially removed, the product held up to light creates an effect simulative of stained glass.

According to another embodiment of the present invention, a workpiece for making simulated stained glass art includes a first transparent sheet, the first transparent sheet have an inherent solid color and a second transparent sheet disposed separately from the first transparent sheet and adjacent to a first surface of the second transparent sheet, the second transparent sheet being colored. A removable by scratching completely opaque layer covers a second surface of the first transparent sheet substrate, the second surface being on an opposite side of the first surface, whereby the opaque layer can be partially removed in selected patterns by scratching with a tool or with fingers to reveal the second transparent sheet through the first transparent sheet.

Either one of the first or second transparent sheet can be a semi-rigid or rigid substrate and the other one of the first or second transparent sheet can be a cellophane sheet. The second transparent sheet can be either a single color sheet or a multi-colored sheet.

In a product according to this embodiment of the present invention, the first transparent sheet and the second transparent sheet are juxtaposed in proximity to one another. After the opaque coating has been partially removed, the product held up to light creates an effect simulative of stained glass. A kit includes at least one workpiece according to this embodiment and the tool for scratching the opaque layer.

According to yet another embodiment of the present invention, a workpiece for making simulated stained glass art includes a colored semi-transparent sheet substrate and a removable by scratching completely opaque layer covering a top surface of the colored semi-transparent sheet substrate. The opaque layer can be partially removed in selected patterns by scratching with a tool or with fingers to reveal the colored semi-transparent sheet. After the opaque coating layer has been at least partially removed, the workpiece held up to light creates an effect simulative of stained glass. The semi-transparent colored sheet can be a multi-colored sheet. A kit includes at least one workpiece according to this embodiment and the tool for scratching the opaque layer.

According to still another embodiment of the present invention, a workpiece for making simulated stained glass art includes a transparent colored sheet and a clear, transparent plastic sheet substrate disposed separately from the transparent colored sheet and adjacent to a first surface of the transparent plastic sheet substrate. A removable by scratching completely opaque layer covers a second surface of the transparent plastic sheet, the second surface being on an opposite side of the first surface, whereby the opaque layer can be partially removed in selected patterns by scratching with a tool or with fingers to reveal the transparent color sheet through the clear transparent sheet substrate.

In a product the transparent colored sheet and the clear, transparent plastic sheet are juxtaposed in proximity to one another. After the opaque coating has been partially removed, the product held up to light creates an effect simulative of stained glass. A kit includes at least one workpiece according to this embodiment of the present invention and the tool for scratching the opaque layer.

A workpiece for making simulated stained glass art includes a transparent colored sheet and a clear, transparent plastic sheet substrate disposed separately from the transparent colored sheet and adjacent to a first surface of the transparent colored sheet substrate. A removable by scratching completely opaque layer covers a second surface of the transparent colored sheet, the second surface being on an opposite side of the first surface, whereby the opaque layer can be partially removed in selected patterns by scratching with a tool or with fingers to reveal the transparent color sheet. The transparent colored sheet includes a transparent ink layer directly printed onto a transparent sheet on a surface opposite the surface on which the opaque layer resides.

In a product according to this embodiment of the present invention, the transparent colored sheet and the clear, transparent plastic sheet substrate are juxtaposed in proximity to one another. After the opaque coating has been partially removed, the product held up to light creates an effect simulative of stained glass. A kit includes at least one workpiece according to this embodiment of the present invention and the tool for scratching the opaque layer.

A workpiece for making simulated stained glass art includes a transparent colored sheet, a first transparent sheet disposed separately from the transparent colored sheet and adjacent to a first surface of the transparent plastic sheet substrate, and a second transparent sheet disposed separately from the transparent colored sheet and the first transparent sheet, the second transparent sheet having a first surface adjacent to a second surface of the first transparent plastic sheet, the second surface being on a side opposite of the transparent colored sheet than the first surface. A removable by scratching completely opaque layer covers a second surface of the second transparent plastic sheet, the second surface of the second transparent plastic sheet being on an opposite side of the first surface of the second transparent plastic sheet, whereby the opaque layer can be partially removed in selected patterns by scratching with a tool or with fingers to reveal the transparent color sheet through the second transparent sheet. The first transparent sheet can be a colored plastic sheet. The second transparent sheet includes a transparent ink layer directly printed onto a transparent sheet on a surface opposite the surface on which the opaque layer resides. Either one of the first or second transparent sheet can be a semi-rigid or rigid substrate and the other one of the first or second transparent sheet can be a cellophane sheet.

In a product according to this embodiment of the present invention, the transparent colored sheet, the first transparent sheet and the second transparent sheet are juxtaposed in proximity to one another. After the opaque coating has been partially removed, the product held up to light creates an effect simulative of stained glass. A kit includes at least one workpiece according to this embodiment of the present invention and the tool for scratching the opaque layer.

### BRIEF DESCRIPTION OF THE DRAWINGS

Preferred embodiments of the present invention will be described in more detail in the following detailed description when taken in conjunction with the attached drawings, in which:

FIG. 1 is a schematic sectional view of coated blank along with a stick tool used to scrape part of the coating from the blank in accordance with an embodiment disclosed in U.S. Pat. No. 5,280,087;

FIG. 2 is a schematic rear or bottom view of a printed pattern on the back side of a blank such as that shown in FIG. 1 in accordance with the embodiments disclosed in U.S. Pat. No. 5,280,087;

FIG. 3 is a schematic front or top view of a scratched sketch on an art blank such as that shown in FIG. 1 having a rear pattern similar to that shown in FIG. 2 in accordance with the embodiments disclosed in U.S. Pat. No. 5,280,087;

FIG. 4 is another schematic front or top view of a scratched sketch, different from that of FIG. 3, on an art blank such as that shown in FIG. 1 having a rear pattern similar to that shown in FIG. 2 in accordance with the embodiments disclosed in U.S. Pat. No. 5,280,087;

FIG. 5 is a schematic sectional view of another embodiment disclosed in U.S. Pat. No. 5,270,087;

FIG. 6 is a schematic sectional view of a workpiece according to one embodiment of the invention;

FIG. 7 is a schematic sectional view of a workpiece according to another embodiment of the invention;

FIG. 8 is a schematic sectional view of a workpiece according to another embodiment of the invention;

FIG. 9 is a schematic sectional view of a workpiece according to another embodiment of the invention;

FIG. 10 is a schematic sectional view of a workpiece according to another embodiment of the invention;

FIG. 11 is a schematic sectional view of a workpiece according to another embodiment of the invention; and

FIG. 12 is a schematic side view of a light box placed adjacent to a product according to an embodiment of the present invention.

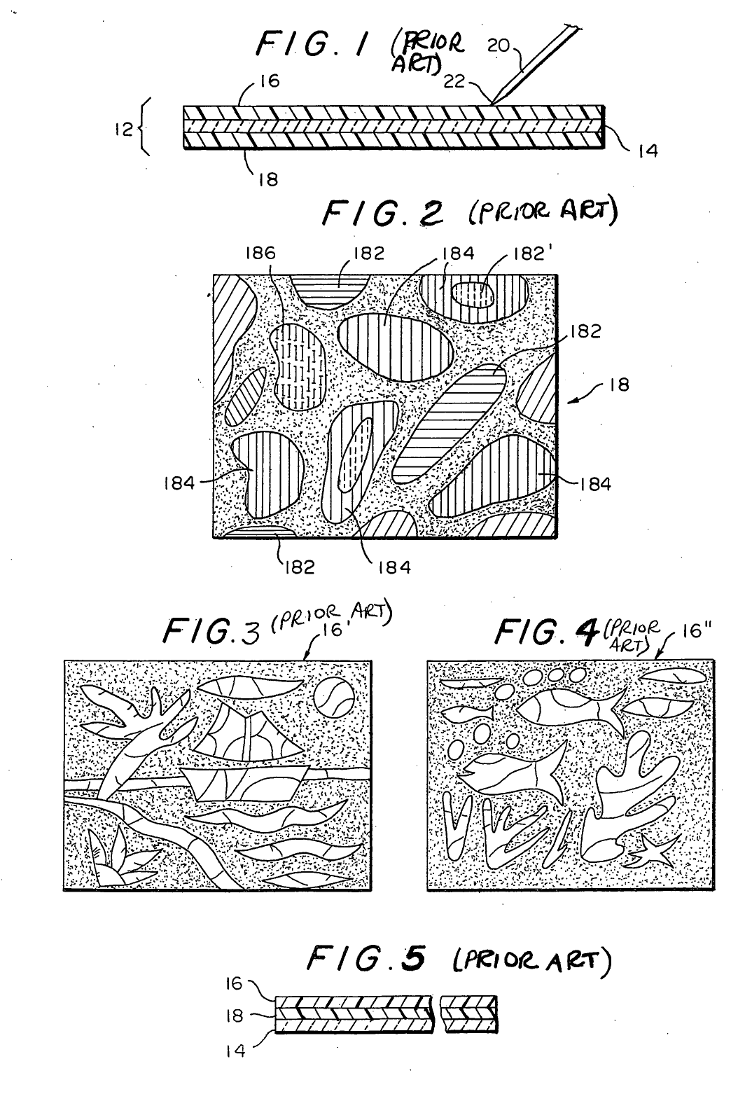

### DETAILED DESCRIPTION OF THE EMBODIMENTS

The workpiece and resultant product of the present invention begin with a first or upper, transparent flat plastic sheet, preferably rigid or semi-rigid. A single or multiple layer coating made with plural, different colored transparent inks is placed adjacent to a top side of a lower or second sheet, i.e., a sheet substrate separate from the first or upper transparent flat plastic sheet, while a removable (by scratching with a scratch tool, fingers, or the like) opaque top coat covers the top side of the first or upper transparent flat plastic sheet. The two sheets are juxtaposed in proximity with the first transparent flat plastic sheet overlaying and are desirably, but not necessarily, mountable or adherable to the underlying second substrate having colors applied thereto.

Scratching through the opaque topcoat on the upper transparent sheet will reveal the colors therebeneath on the underlying substrate. The opaque top coat or scratchable, malleable opaque ink layer may be an ink or paint which is manipulatable with the use of fingers, as well as tools. Such an ink or paint may include such materials commonly known as “finger paint” and permitting the alteration of opacity by reflection of such finger paint and/or its thickness of application.

The drawn picture art achieved by selective scratching or finger painting on the upper sheet will thus be opaque or have varying degrees of opacity except where it has been scratched to remove the coating from the upper transparent sheet. When the product is held up to the light, the transparent inks used on the underlying sheets will produce visual effects that simulate stained glass. Additionally, the solid, malleable ink or paint on the upper transparent colored or clear sheet may be of such a nature, with the physical property of being manipulatable with the fingers, as to achieve effects associated with the art and technique of finger painting, with or without a light source behind the product.

In one embodiment, the color printed substrate below the upper sheet is a clear or frosted plastic sheet, and the transparent coated plastic sheet located there above is completely separate from the lower substrate or subsequently adhereable thereto.

Another embodiment is similar to the first embodiment, except that the bottom sheet does not have colors printed thereon, but is instead a colored transparent or translucent plastic sheet with the upper transparent sheet of the first embodiment placed thereover.

A kit in accordance with the present invention may include one or more of the aforementioned workpiece or other embodiments, or components thereof, in accordance with the present invention, along with one or more scrapping tools, directions and an optional light source, e.g., a light box comprising a light bulb, a means to provide electricity, e.g., a circuit adapted to retain a battery, and a translucent sheet of plastic, paper or vellum above the light bulb to disperse the light, the latter being desirable if the lower substrate is transferred rather than frosted or translucent.

A prepared pre-scratch blank or workpiece 622 is shown in FIG. 6, along with a scratch tool 20. The pre-scratch blank 622 is preferably made up three main layers.

The middle layer substrate 24 is preferably made of a generally clear transparent or translucent plastic sheet material, such as rigid or semi-rigid, and unpigmented PVC, cellulose acetate, polystyrene, clear polypropylene, ABS, etc., of at least 3 mils thickness, preferably 3-10 mils thickness. The substrate 24 can either be completely clear, or be frosted (sufficiently lightly so as to allow light to pass through the substrate)), either solidly, or in a pattern or design of some kind. Substrate 24 may also be a film or sheet with a solid color inherent therein, such as cellophane or another solidly colored transparent sheet wherein the color is inherent in the film or sheet. One side of the middle layer 24 is coated or printed with a removable (by scratching with a scratch tool 20, finger, or the like) continuous opaque layer 26. Opaque layer 26 may be black or any other opaque color.

As in U.S. Pat. No. 5,280,087, the scratch tool 20 can be made of wood and can be as simple as an elongated stick that can have a stylus 22 or point carved into at least one end. Fingers may also be used. In at least some cases, other types of scratch tools can be used, e.g., formed of metal, plastic or other hard material, and optionally with different types of points at the ends thereof.

The opaque layer 26 may be formed of any opaque coating material, i.e., one that is not transparent to light. According to one embodiment, however, a well-known ink known as “malleable black” is used that is a printing ink known in the printing industry which poorly bonds to whatever surface it is applied. These malleable black inks, which may be colors other than black, are conventionally used on coin-scratch contest forms to cover a hidden message therebeneath and which are easily scratched away by using the edge of a coin. Alternative, an opaque paint, such as finger paint may be used which can be scratched off with the fingers or a tool. While the scratchable or malleable ink or paint according to the present invention may be black, it may also be any other desired or selected colors or colors.

When the construction of FIG. 6 is prepared for use by children, i.e., the scratch tool 20 is formed of wood, then the opaque coating is an easily removable material such as malleable black or a paint which can be removed by one's fingers. On the other hand, if the device of FIG. 6 is constructed for use by adults, wherein the scratch tool 20 is formed of metal and is provided with a sharper stylus 22, more tightly adherent opaque inks could be used. Thus, in place of malleable black, one may use a regular opaque black, e.g. black printers ink. The opaque covering may require two or three printing passes to provide sufficient opacity.

Adapted to be placed adjacent and in proximity to the opposite side of the clear middle layer substrate 24 is a coated or printed color layer 28. The color layer 28 is provided separately from the substrate 24. The color layer 28 can be juxtaposed in proximity to the clear substrate layer 24 and either the substrate layer 24 can either be lain down on top of the color layer 28, and/or it can be attached in any non-permanent manner to the color layer 28. The color layer 28 can have a single color or can be multiple colors, in any pattern or design.

In a similar manner to that disclosed in U.S. Pat. No. 5,280,087 (see FIG. 3 and FIG. 4), when the scratched blanks are held against light and looked at from the scratched side (see FIG. 12), the transparent inks will provide an effect simulative of stained glass. Transparent colors will appear only where the opaque coating 26 has been scratched off as the light shines through. In addition to a pattern of several printed colors viewable behind the substrate upon which the scratchable or malleable ink or paint is disposed, a single color may be used on the same or other surface positioned behind said substrate to complete the stained glass effect achievable when the substrate is illuminated from behind.

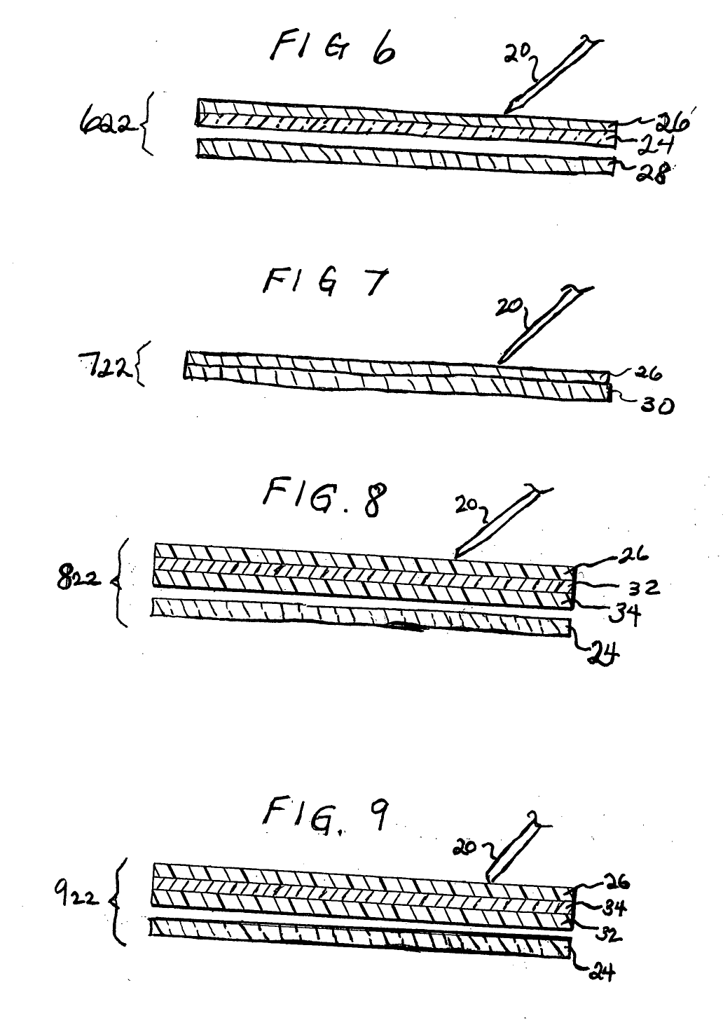

FIG. 7 through FIG. 11 illustrate alternative embodiments of the present invention. These figures will be described below to the extent the embodiments are different that the embodiment illustrated in FIG. 6 and described above.

The embodiment of FIG. 7 comprises a workpiece 722, which includes a colored, transparent or semi-transparent substrate 30, coated on one side with an opaque layer 26 which can be scratched off as described above with respect to FIG. 6. The colored substrate 30 can either be clear or frosted as described above with respect to FIG. 6. The combination of the substrate layer and the colored layer allows the workpiece of the present invention to be manufactured for less money. The substrate 30 may be a plastic sheet or film that is colored in a solid color or in a pattern or design. When the coating is scraped from the upper surface of the colored substrate 30, the “stained glass” effect is provided by the color of the substrate itself.

The embodiment of FIG. 8 comprises a workpiece 822, which includes a clear substrate 24 provided as a bottom layer. Provided separately from the substrate 24 is a sheet that includes three layers. A coated layer 26 is provided on one side of a colored transparent sheet 32, and a colored transparent sheet 34 is adhered to the other side of colored sheet 32. The colored sheet 34 can be a different color than that of colored sheet 32, so that the combination of the two colors makes a third color.

The embodiment of FIG. 9 comprises a workpiece 922, which is similar to that of FIG. 8, however, the position of the colored transparent sheet 32 and the colored transparent sheet 34 are switched.

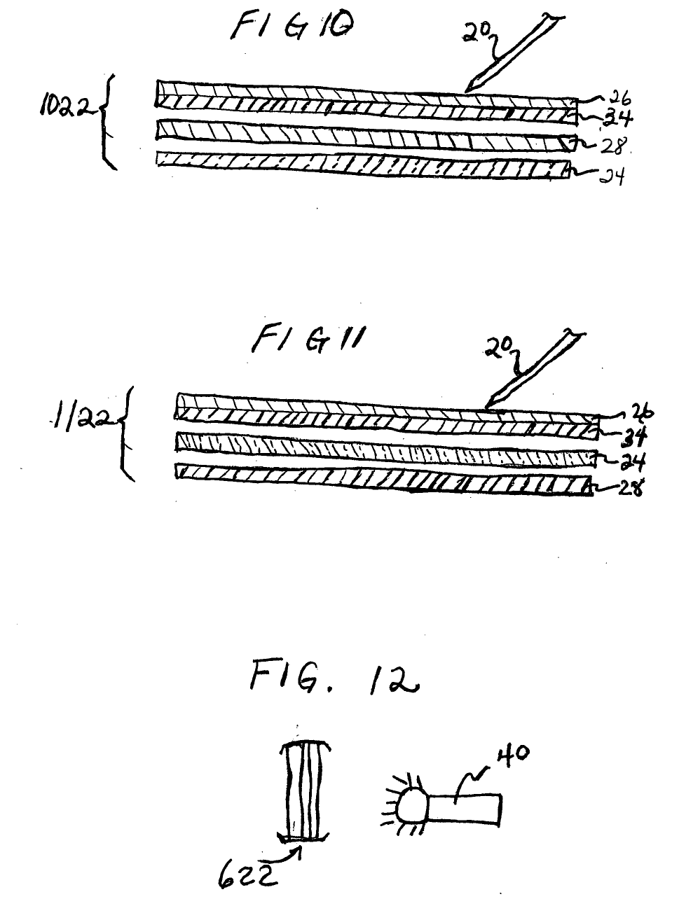

The embodiment of FIG. 10 includes a workpiece 1022 that includes a colored transparent sheet 34, which includes an opaque coating layer 26 on one side. The color layer 28 is provided as a separate colored sheet on the other side of colored transparent sheet 34 from the opaque coating layer 26, either as a solid color or having a pattern or design. Additionally, the clear substrate 24 is provided as a separate sheet on the other side of the color layer 28 from the opaque coating layer 26.

The embodiment of FIG. 11 includes a workpiece 1122 is similar to the embodiment of FIG. 10, however, the positions of the clear substrate 24 and the color layer 28 are reversed.

The present invention includes a kit that can be sold including one or more workpieces 622 (or workpieces 722-1122 described above), i.e., the various sheets and/or substrates making up those workpieces, and one or more tools 20 which can be used to scratch the coating layer from the top sheet. Multiple sheets of each kind can be included in the kits, with different colors and patterns, so that the user can mix and match the sheets as desired.

FIG. 12 illustrates a side view of a workpiece 622 placed adjacent to and in proximity to an artificial light source, such as, for example, a lamp or light box, to allow light to shine through the scratched-off opaque layer to the colored layer adjacent thereto. The two layers are mounted in close proximity to one another to achieve the stained-glass effect according to the present invention.

The above-described invention will greatly simplify and make cost-effective the production of simulated stained glass works of art, such as windows. Furthermore, the invention provides an excellent and novel vehicle for free-hand art in a highly direct method.

Also, by eliminating the need for glass cutting, the present invention will provide great safety advantages. The present invention is safe and easy to use such that even young children can utilize it.

Further, by providing separate layers, in whole or in part, as part of the kits, the user may pick and choose the particular construction he desires, so as to have more variety in the color combinations achievable by the present invention.

Any combination of substrates and applied inks and paints as described above and viewed vertically or horizontally may be utilized in a projection technique or device for the viewing and appreciation of the completed art.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

1. A workpiece for making simulated stained glass art comprising:
a clear, transparent plastic sheet substrate;
a transparent colored sheet disposed separately from said clear plastic sheet substrate and adjacent to a first surface of said clear plastic sheet substrate; and
a removable by scratching completely opaque layer covering a second surface of said clear plastic sheet substrate, said second surface being on an opposite side of said first surface, whereby said opaque layer can be partially removed in selected patterns by scratching with a tool or with fingers to reveal the transparent color sheet through said clear transparent sheet substrate.

2. The workpiece of claim 1 wherein said opaque layer is malleable black or any other malleable color.

3. The workpiece of claim 1 wherein said removable-by-scratching completely opaque layer is formed of an ink or paint coating.

4. The workpiece of claim 1 wherein said transparent colored sheet is either a single color sheet or a multi-colored sheet.

5. A kit comprising at least one workpiece of claim 1 and the tool for scratching the opaque layer.

6. A product comprising the workpiece of claim 1 wherein the clear and the transparent colored sheet are juxtaposed in proximity to one another.

7. The product of claim 6 wherein, after the opaque coating has been partially removed, the product held up to light creates an effect simulative of stained glass.

8. A workpiece for making simulated stained glass art comprising:
a first transparent sheet, said first transparent sheet have an inherent solid color;
a second transparent sheet disposed separately from said first transparent sheet and adjacent to a first surface of said second transparent sheet, said second transparent sheet being colored; and
a removable by scratching completely opaque layer covering a second surface of said first transparent sheet substrate, said second surface being on an opposite side of said first surface, whereby said opaque layer can be partially removed in selected patterns by scratching with a tool or with fingers to reveal the second transparent sheet through said first transparent sheet.

9. The workpiece of claim 8 wherein either one of said first or second transparent sheet is a semi-rigid or rigid substrate and the other one of said first or second transparent sheet is a cellophane sheet.

10. The workpiece of claim 8 wherein said second transparent sheet is either a single color sheet or a multi-colored sheet.

11. A product comprising the workpiece of claim 8 wherein the first transparent sheet and the second transparent sheet are juxtaposed in proximity to one another.

12. The product of claim 11 wherein, after the opaque coating has been partially removed, the product held up to light creates an effect simulative of stained glass.

13. A kit comprising at least one workpiece of claim 8 and the tool for scratching the opaque layer.

14. A workpiece for making simulated stained glass art comprising:
a colored semi-transparent sheet substrate; and
a removable by scratching completely opaque layer covering a top surface of said colored semi-transparent sheet substrate, whereby said opaque layer can be partially removed in selected patterns by scratching with a tool or with fingers to reveal the colored semi-transparent sheet, wherein, after the opaque coating layer has been at least partially removed, the workpiece held up to light creates an effect simulative of stained glass.

15. The workpiece of claim 14 wherein said semi-transparent colored sheet is a multi-colored sheet.

16. A kit comprising at least one workpiece of claim 14 and the tool for scratching the opaque layer.

17. A workpiece for making simulated stained glass art comprising:
a transparent colored sheet;
a clear, transparent plastic sheet substrate disposed separately from said transparent colored sheet and adjacent to a first surface of said transparent plastic sheet substrate; and
a removable by scratching completely opaque layer covering a second surface of said transparent plastic sheet, said second surface being on an opposite side of said first surface, whereby said opaque layer can be partially removed in selected patterns by scratching with a tool or with fingers to reveal the transparent color sheet through said clear transparent sheet substrate.

18. A product comprising the workpiece of claim 17 wherein the transparent colored sheet and the clear, transparent plastic sheet are juxtaposed in proximity to one another.

19. A kit comprising at least one workpiece of claim 17 and the tool for scratching the opaque layer.

20. A workpiece for making simulated stained glass art comprising:
a transparent colored sheet;
a clear, transparent plastic sheet substrate disposed separately from said transparent colored sheet and adjacent to a first surface of said transparent colored sheet substrate; and
a removable by scratching completely opaque layer covering a second surface of said transparent colored sheet, said second surface being on an opposite side of said first surface, whereby said opaque layer can be partially removed in selected patterns by scratching with a tool or with fingers to reveal the transparent color sheet.

21. The workpiece of claim 20 wherein said transparent colored sheet comprises a transparent ink layer directly printed onto a transparent sheet on a surface opposite the surface on which said opaque layer resides.

22. A product comprising the workpiece of claim 20 wherein the transparent colored sheet and the clear, transparent plastic sheet substrate are juxtaposed in proximity to one another.

23. The product of claim 22 wherein, after the opaque coating has been partially removed, the product held up to light creates an effect simulative of stained glass.

24. A kit comprising at least one workpiece of claim 20 and the tool for scratching the opaque layer.

25. A workpiece for making simulated stained glass art comprising:
a transparent colored sheet;
a first transparent sheet disposed separately from said transparent colored sheet and adjacent to a first surface of said transparent plastic sheet substrate;
a second transparent sheet disposed separately from said transparent colored sheet and said first transparent sheet, said second transparent sheet having a first surface adjacent to a second surface of said first transparent plastic sheet, said second surface being on a side opposite of said transparent colored sheet than said first surface; and
a removable by scratching completely opaque layer covering a second surface of said second transparent plastic sheet, said second surface of said second transparent plastic sheet being on an opposite side of said first surface of said second transparent plastic sheet, whereby said opaque layer can be partially removed in selected patterns by scratching with a tool or with fingers to reveal the transparent color sheet through said second transparent sheet.

26. The workpiece of claim 25 wherein said first transparent sheet is a colored plastic sheet.

27. The workpiece of claim 25 wherein said second transparent sheet comprises a transparent ink layer directly printed onto a transparent sheet on a surface opposite the surface on which said opaque layer resides.

28. The workpiece of claim 25 wherein either one of said first or second transparent sheet is a semi-rigid or rigid substrate and the other one of said first or second transparent sheet is a cellophane sheet.

29. A product comprising the workpiece of claim 25 wherein the transparent colored sheet, the first transparent sheet and the second transparent sheet are juxtaposed in proximity to one another.

30. The product of claim 29 wherein, after the opaque coating has been partially removed, the product held up to light creates an effect simulative of stained glass.

31. A kit comprising at least one workpiece of claim 25 and the tool for scratching the opaque layer.
